(19) United States
(12) Patent Application Publication
(10) Pub. No.: US 2023/0394431 A1
(43) Pub. Date: Dec. 7, 2023

(54) METHOD OF FULFILLMENT ORDERS AND SYSTEM THEREOF

(71) Applicant: WIZART - ONLINE LTD, Tel Aviv-Yafo (IL)

(72) Inventor: Daniel FRIED, Yokneam Hamoshava (IL)

(21) Appl. No.: 18/234,975

(22) Filed: Aug. 17, 2023

Related U.S. Application Data
(63) Continuation of application No. PCT/IL2022/050183, filed on Feb. 16, 2022.

(51) Int. Cl. G06Q 10/087; B65G 1/137

(52) U.S. Cl. CPC G06Q 10/087; B65G 1/1371

(57) ABSTRACT

There is provided a technique of computerized orders' fulfilling. The technique comprises: obtaining a grouped product-list corresponding to a plurality of orders received from a plurality of users and grouped into at least one batch of orders, each product in the grouped product-list being associated with a respective product ID and order ID; dividing the grouped product-list into a plurality of picking lists, each product in the picking lists being respectively associated with product ID and order ID; and enabling picking items per the plurality of picking lists to yield a plurality of corresponding item subgroups (ISGs), wherein, in each ISG, picked items therein match to products in a respective picking list. The technique further comprises obtaining data informative of mapping between order IDs in the at least one batch of orders and destinations on a conveyor and, separately for each ISG and/or a predefined group of ISGs, placing the items therefrom on the conveyor and recognizing the items using data from one or more sensors sensing the items on the conveyor, thereby associating the items with product IDs of respective matching products. For each given recognized item, the associated product ID is used to further associate the given item with respective order ID, thereby yielding identified items; and the associated order IDs is further used to sort the identified items to destinations defined in accordance with the data informative of mapping between the destinations and order IDs.

### CROSS-REFERENCES TO RELATED APPLICATIONS

The present application is a continuation of International Application No. PCT/IL2022/050183 filed on Feb. 16, 2022 which claims benefit from 63/200,146 filed on Feb. 17, 2021 and 63/200,944 filed on Apr. 5, 2021, the entire contents of which are hereby incorporated by reference in their entirety.

### TECHNICAL FIELD

The presently disclosed subject matter relates, in general, to the field of automated order management, and more specifically, to methods and systems for automating the orders' fulfillment.

### BACKGROUND

Effective order fulfillment is becoming ever more important in the course of the changing way of the ordering and supply of goods. The term “order fulfillment” used in this patent specification should be expansively construed to cover any process converting an on-line product inquiry into delivery of a physical product to a desired location. For example, in the context of a retail store, the term “order fulfillment” may refer to a process from receiving an order for one or more products (e.g. via the Internet) to enabling delivery of the ordered products to collecting points for packaging.

Problems of automating the order fulfillment have been recognized in the conventional art and various techniques have been developed to provide solutions, for example:

US Patent Application No. 2020/0005384 discloses a computer-implemented palletizing system to coordinate the discrete activities of one or more pickers and conveyor sorting assembly to allocate a plurality of products to a plurality of pallets.

US Patent Application No. 2020/0324974 discloses coordinated conveyors in an automated system. In an embodiment, the system comprises transport conveyor(s) and storage conveyors, wherein each storage conveyor comprises a plurality of segments configured to hold at least one item, and a portion that is aligned with a portion of a transport conveyor, such that items are moveable from the storage conveyor to the transport conveyor. Software module(s) receive an instruction to collect item(s) at a single destination location, and, for each of the item(s), identify a segment on a storage conveyor on which the item is held, control that storage conveyor to align the segment with the transport conveyor, move the item from the segment onto the transport conveyor, control the transport conveyor to align the item with the destination location, and move the item from the transport conveyor to the destination location.

US Patent Application No. 2018/0134492 discloses a technique for combining automated-service and self-service store for implementation at brick-and-mortar retail locations. The store and corresponding method of implementation is an automated-service model in which robots, deployed at the brick-and-mortar location, fill orders for fungible goods placed by customers either online or in-store. The store also includes a shopping section where customers can select/order items and/or personally select non-fungible goods. The store includes a shopping section for non-fungible goods that customers prefer to pick out by hand and a back end automated order fulfillment section for other goods (e.g., fungible goods, dry goods, etc.). The two sets of goods are merged to a delivery bundle and delivered together for pickup by the customer. The combination automated-service and self-service store combines the convenience of online shopping and self-service shopping using an unconventional approach that reduces costs for the retailer and simultaneously increases customer satisfaction

US Patent Application No. 2018/0194573 discloses an imaging unit that has its imaging field of view containing the conveyor, and images a subject in the imaging field. The imaging unit generates a luminance image representing the subject and a range image including height information indicating a height of at least one point on the subject from the conveyor by imaging the subject. A measurement unit measures a position of each workpiece in the luminance image. An obtaining unit obtains an overlap order of the workpieces based on the height information in the range image corresponding to the position of each workpiece in the luminance image. A determination unit determines the workpiece pickup order to allow a workpiece having a highest place in the overlap order to be picked up with a higher priority than other workpieces.

US Patent Application No. 2016/0075521 discloses a storage and order-picking system for the fully-automated picking of articles that are stored in storage loading aids and are picked according to an order, which includes an article store, a first conveyor system that conveys storage loading aids leaving the article store to a picking station that is operated unmanned, a fully-automated robotic gripping unit on said picking station, which removes articles to be picked from said storage loading aids and deposits them in accordance with the order, the articles deposited according to an order, particularly in an order loading aid, subsequently being conveyed away by means of a second conveyor system, an image identification device for determining possible gripping points for the gripping unit in order to grip articles from the storage loading aids, wherein the image identification device comprises at least one and preferably at least two cameras in the region of the robotic gripping unit and, if at least two cameras are provided, the capturing directions thereof are aligned into the storage loading aid located in the gripping region of the gripping unit, while being coordinated and in particular inclined toward each other.

The references cited above teach background information that may be applicable to the presently disclosed subject matter. Therefore, the full contents of these publications are incorporated by reference herein where appropriate for appropriate teachings of additional or alternative details, features and/or technical background.

### General Description

In accordance with certain aspects of the presently disclosed subject matter, there is provided a computerized method of orders' fulfilling. The method comprises, by a computer: obtaining a grouped product-list corresponding to a plurality of orders received from a plurality of users and grouped into at least one batch of orders, each product in the grouped product-list being associated with a respective product ID and order ID and dividing the grouped product-list into a plurality of picking lists, each product in the picking lists being respectively associated with product ID and order ID. The method further comprises: enabling picking items per the plurality of picking lists to yield a plurality of corresponding item subgroups (ISGs), wherein, in each PSG, picked items therein match to products in a respective picking list; obtaining data informative of mapping between order IDs in the at least one batch of orders and destinations on a conveyor; separately for each ISG and/or a predefined group of ISGs, placing the items therefrom on the conveyor and recognizing the items using data from one or more sensors sensing the items on the conveyor, thereby associating the items in a given ISG and/or a predefined group of ISGs with product IDs of respective matching products; for each given recognized item, using the associated product ID to further associate the given item with respective order ID, thereby yielding identified items; and using the associated order IDs to sort the identified items to destinations defined in accordance with the data informative of mapping between the destinations and order IDs.

In accordance with further aspects and, optionally, in combination with other aspects of the presently disclosed subject matter, the method further comprises, for each ISG: upon placing items from a given ISG on the conveyor, obtaining sensor data informative of the items in a given ISG and obtaining data informative of products and respective order IDs specified in a corresponding picking list; processing the sensor data and data informative of products to define, for each item, a matching product among the products in the corresponding picking list; for each item, when a confidence level of matching meets a recognition criterion, associating the item with product IDs of the respective matching products to yield recognized items; for each recognized item, using respective associated product ID to associate the item with an order ID among the order IDs specified in the corresponding picking list, the order ID further usable for sorting the item to a respective destination.

In accordance with further aspects and, optionally, in combination with other aspects of the presently disclosed subject matter, the method further comprises: enabling picking the items in at least one ING into one or more crates, each crate associated with a respective crate ID; obtaining data indicative of product IDs of the items placed in each of the one or more crates and associating each crate ID with the respective product IDs; for each of the one or more crates, using the product IDs associated with its crate ID to define a “queue score” indicative of a priority of placing the items from the crate on the conveyor; and enabling uploading the items from the crates on the conveyor in accordance with the queue scores of respective crates.

Optionally, the queue scores of the one or more crates can be calculated in accordance with requirements related to further packaging the items in the orders.

Optionally, each product in a picking list corresponding to the at least one ISG can be associated with a queue score assigned thereto, and the queue score of each crate can be calculated as a function of queue scores of the respective items therein.

Optionally, each product in a picking list corresponding to the at least one ISG can be associated with a category of products with a preassigned queue score, and the queue score of each crate can be calculated as a function of queue scores of the categories associated with respective items therein.

In accordance with further aspects and, optionally, in combination with other aspects of the presently disclosed subject matter, at least one picking list can be configured to enable picking the items in an order defined in accordance with requirements related to further packaging the respective items.

In accordance with further aspects and, optionally, in combination with other aspects of the presently disclosed subject matter, the method further comprises: recognizing, within at least one picking list, one or more products with the same packageability requirements and associated with a common order ID; enabling placing the items corresponding to the recognized one or more products in a common physical basket matching the packageability requirements; and enabling sorting the physical basket on the conveyor to a destination corresponding to the common order ID.

The method can further comprise: generating within the at least one picking list at least one bundle specifying the one or more products with the same packageability requirements and associated with the common order ID; enabling placing the items matching the at least one bundle in the common physical basket and providing the physical basket with basket ID associated with the common order ID and with the product IDs of the items placed therein; and upon placing the physical baskets on the conveyor, recognizing the basket ID and sorting the physical basket on the conveyor to the destination corresponding to the order ID associated with the recognized basket ID.

The method can further comprise: generating within the at least one picking list a plurality of bundles associated with the common order ID and aggregating the bundles into an aggregated bundle; for each bundle, enabling placing the items matching a given bundle in a respective common physical basket to yield a plurality of physical baskets corresponding to the plurality of bundles; enabling placing the plurality of physical baskets into an aggregated physical basket and assigning to the aggregated physical basket a basket ID associated with the common order ID and with the basket IDs of the physical baskets placed therein; and upon placing the aggregated physical basket on the conveyor, recognizing the basket ID and sorting the aggregated physical basket on the conveyor to the destination corresponding to the common order ID.

In accordance with further aspects and, optionally, in combination with other aspects of the presently disclosed subject matter, at least one product (CS product) in at least one picking list can be associated with a customization specification informative of the order ID and of user-specified requirements for the at least one CS product, the requirements being beyond details indicatable by product ID. The method further comprises: upon picking a CS item corresponding to the at least one CS product, using the customized specification to identify order ID corresponding to the CS item and providing the CS item with a recognizable CS marking informative of a destination assigned in accordance with the order ID; and upon placing the CS item on the conveyor, recognizing the CS marking and sorting the CS item to the destination corresponding to the recognized CS marking.

In accordance with other aspects of the presently disclosed subject matter, there is provided a system configured to enable order fulfillment, the system configured to operate in accordance with the method detailed with reference to the above aspects.

In accordance with other aspects of the presently disclosed subject matter, there are provided one or more computing devices comprising processors and memory, the one or more computing devices configured, via computer-executable instructions, to perform operations for operating, in a cloud computing environment, a system capable of managing order fulfilment. The operations comprise: obtaining a grouped product-list corresponding to a plurality of orders received from a plurality of users and grouped into at least one batch of orders, each product in the grouped product-list being associated with a respective product ID and order ID; dividing the grouped product-list into a plurality of picking lists, each product in the picking lists being respectively associated with product ID and order ID; enabling picking items per the plurality of picking lists to yield a plurality of corresponding item subgroups (ISGs), wherein, in each PSG, picked items therein match to products in a respective picking list; obtaining data informative of mapping between order IDs in the at least one batch of orders and destinations on a conveyor; separately for each ISG and/or a predefined group of ISGs, placing the items therefrom on the conveyor and recognizing the items using data from one or more sensors sensing the items on the conveyor, thereby associating the items in a given ISG and/or a predefined group of ISGs with product IDs of respective matching products; for each given recognized item, using the associated product ID to further associate the given item with respective order ID, thereby yielding identified items; and using the associated order IDs to sort the identified items to destinations defined in accordance with the data informative of mapping between the destinations and order IDs.

The one or more computing devices can be further configured to perform operations of the method detailed with reference to the above aspects.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 illustrates a generalized flow-chart of a computer-implemented method of order fulfilment in accordance with certain embodiments of the presently disclosed subject matter;

FIGS. 2a-2b illustrate generalized flow-charts of the computerized order fulfilment with optimized placing of the items on the conveyer in accordance with certain embodiments of the presently disclosed subject matter;

FIG. 3 illustrates a generalized flow-chart of the computerized order fulfilment with regard to customizable products in accordance with certain embodiments of the presently disclosed subject matter.

FIG. 4 illustrates a generalized block diagram of a managing computer system (MCS) in accordance with certain embodiments of the presently disclosed subject matter;

FIG. 5 illustrates a generalized schematic architecture of an exemplified order fulfilment system (OFS) in accordance with certain embodiments of the presently disclosed subject matter;

FIG. 6 illustrates a generalized flow-chart of items sorting in accordance with certain embodiments of the presently disclosed subject matter; and

FIGS. 7a and 7b illustrate generalized flow-charts of item recognition in accordance with certain embodiments of the presently disclosed subject matter.

### DETAILED DESCRIPTION OF EMBODIMENTS

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter.

Unless specifically stated otherwise, as apparent from the following discussions, it is appreciated that throughout the specification discussions utilizing terms such as “processing”, “computing”, “identifying”, “associating”, “generating”, “mapping”, “recognizing”, or the like, refer to the action(s) and/or process(es) of a computer that manipulate and/or transform data into other data, said data represented as physical, such as electronic, quantities and/or said data representing the physical objects. The term “computer” should be expansively construed to cover any kind of hardware-based electronic device with data processing capabilities including, by way of non-limiting example, managing computer system and parts thereof disclosed in the present application.

It is appreciated that, unless specifically stated otherwise, certain features of the presently disclosed subject matter, which are described in the context of separate embodiments, can also be provided in combination in a single embodiment. Conversely, various features of the presently disclosed subject matter, which are described in the context of a single embodiment, can also be provided separately or in any suitable sub-combination. In the following detailed description, numerous specific details are set forth in order to provide a thorough understanding of the methods and apparatus.

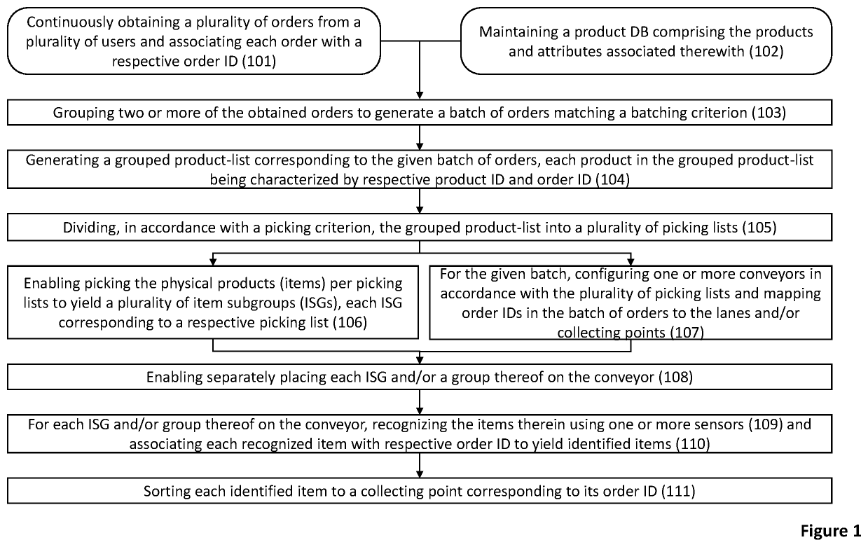

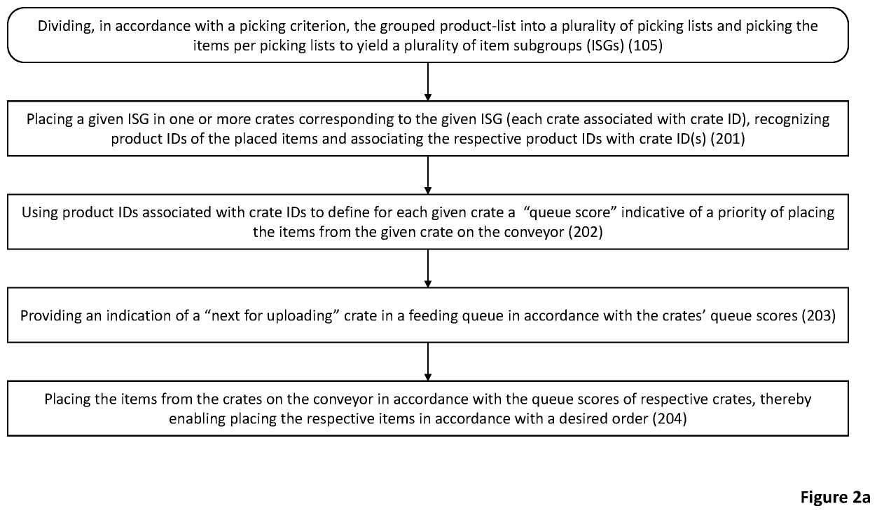

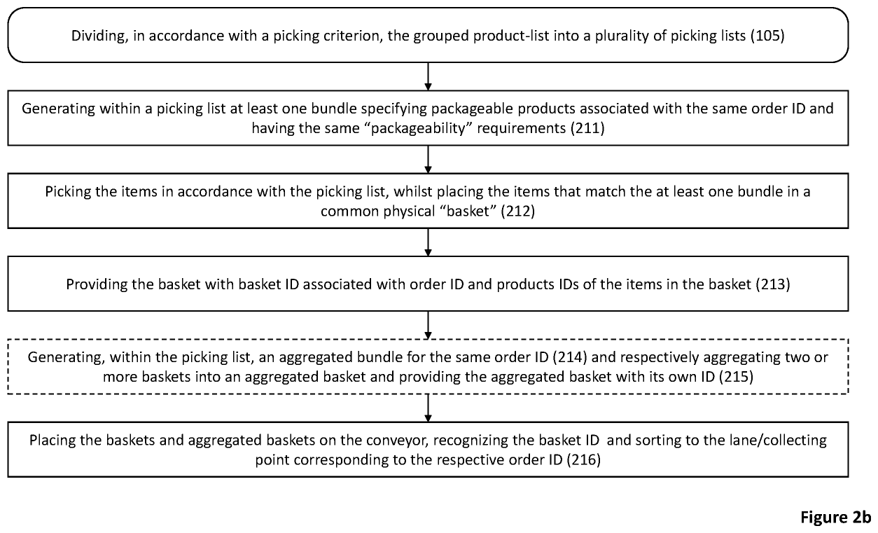

Bearing this in mind, attention is drawn to FIG. 1 illustrating a generalized flow-chart of computer-implemented method of order fulfilment in accordance with certain embodiments of the presently disclosed subject matter. By way of non-limiting example, the illustrated operations can be provided by an order fulfillment system (OFS) with the help of a managing computer system (MCS) comprised therein. OFS and MCS are further detailed with reference to FIGS. 2-7.

OFS continuously obtains online orders from a plurality of users and associates (101) each order with a respective order ID.

OFS can maintain (102) a product database comprising data informative of a plurality of objects (referred to hereinafter as “products”) characterized by respective product IDs and attributes associated with the products. By way of non-limiting example, attributes can include weight, packing characteristics, dimensions, texture, barcode, etc. Alternatively or additionally, attributes can be informative of product categories, for example fungible/non-fungible, food/non-food, freeze/cool/room temperature, crushable/non-crushable, measure, metes & bounds, etc. In accordance with certain embodiments, attributes of a given product can also include data informative of the product's image, for example a product image per ser, derivations of the product image (e.g. color, text and/or graphics on the packages, image template, etc.), product texture, etc.

It is noted that, in certain embodiments, at least part of product-related data can be stored in a database managed by a 3^{rd} party, and maintaining the product data base can include receiving therefrom product-related data pertaining to the obtained orders or parts thereof.

OFS processes the received orders to group two or more orders together, thereby generating (103) a batch of orders matching a batching criterion. The batching criteria characterizes what orders shall be grouped in a single batch. Generating the batches can be provided in accordance with predefined periodicity and/or when the plurality of the orders matches a predefined criterion (e.g. number of orders to a certain shipment area, number of orders with certain due delivery time, and/or load of a product conveyor or parts thereof, etc.). By way of non-limiting example, the batching criterion can be related to the size of the orders to be grouped into the batch (e.g. orders with substantially equal size), type of the ordered products (e.g. orders comprising over-sized products, orders comprising frozen products, due time of delivery, etc.)

It is noted that the term “criterion” used in this patent specification should be expansively construed to include any compound criterion, including, for example, several criteria and/or their logical combinations.

For each given batch of orders, OFS generates (104) a grouped product-list corresponding to the given batch of orders, each product in the grouped product-list being characterized by a respective product ID and order ID. OFS further divides (105) the grouped product-list into a plurality of picking lists to be used by pickers (humans or automated). Pickers are then physically pick the products per picking lists to yield (106) a plurality of item subgroups, each item subgroup corresponding to a respective picking list.

Physically picked products are referred to hereinafter as “items”. A product in a given picking list has a matching item in a respective item subgroup, both the product and the matching item are characterized by the same product ID.

It is noted that, in a given picking list, each product is characterized by a pair of its respective product ID and order ID, while the products with the same product ID can be associated with different orders. Likewise, in a given product group, the items characterized by the same product ID can belong to different orders. It is further noted that a picking list can comprise multiple products characterized by the same product ID and order ID.

The division into the plurality of picking lists is provided in accordance with a picking criterion. By way of non-limiting example, the picking criterion can be related to a number/volume/weight of products in each list, picking time required for each list, categories of products, etc. Optionally, the picking criterion can define that all products in a picking list correspond to the same product category (e.g. fungible/non-fungible, food/non-food, freeze/cool/room temperature, crushable/non-crushable, etc.) and/or to the same packing criterion corresponding to a product category and/or group thereof.

In certain embodiments, all products in a given picking list can be picked by a single picker that, at a time, picks merely the products specified in the given list. Optionally, a picking list can be divided into a plurality of sub-lists and distributed between several pickers, each picker picking merely the products specified in a respective sub-list.

In certain embodiments, the plurality of products can be divided into a plurality of sub-stores in accordance with the products (e.g. apples, bananas, bread, etc.) and/or groups thereof (e.g. dairy, dry, hygiene, alcohol, etc.) and/or physical location thereof. In such embodiments, the picking criterion can be, alternatively or additionally, related to the sub-stores (e.g. all products in the picking list shall correspond to a single sub-store, all products in the picking list shall correspond to an allowable combination of sub-stores, etc.).

For each given batch of orders, OFS defines a configuration of a product conveyor system (referred to hereinafter also as a conveyor), and maps (107) order IDs to the lanes and/or collecting points (collectively referred to hereinafter also as destinations), and generates the respective conveyor configuration instructions in accordance with the provided mapping. The conveyor configuration ((e.g. a number of lanes per a collecting point, number of collecting points per an order, special physical arrangements for certain product categories (e.g. over-sized), etc.) can vary in accordance with the plurality of picking lists in a given batch or can be constant.

It is noted that the term “product conveyor system” used in this patent specification refers to any conveyor system capable of automated (optionally, with human intervention) transporting and distributing the placed physical products to a plurality of destinations in accordance with configuration and/or sorting instructions.

For each batch of orders, OFS applies the generated conveyor configuration instructions to configure the conveyor system accordingly. The conveyor system can be configured with the help of any appropriate technique, some of them known in the art.

The mapping between order IDs and the lanes and/or collecting points can depend on a configuration of a conveyor.

OFS enables picking the physical products (items) per picking lists and placing (108) the items from the respective item subgroups on the conveyor. ISGs are placed on the conveyor in a separated manner to enable recognition of associating the items to respective ISGs.

OFS can provide respective picking lists and placing instructions to a plurality of human and/or automated pickers.

In some embodiments, a picker can place the respective ISGs directly to a conveyor per placing instructions. In other embodiment, the pickers place the ISGs to an automated feeder configured to place the ISGs on the conveyor.

It is noted that in certain embodiments the ISGs can be placed on the conveyor in an arbitrary order subject to enabling recognition between different ISGs.

As will be further detailed with reference to FIG. 2a, OFS can be configured to enable a sequence of placing the item subgroups (and/or items therein) on the conveyor in accordance with a placement criterion. By way of non-limiting example, the placement criterion can be related to product categories (e.g. dimensions, weight, crushability, etc.) and/or packaging considerations.

Upon placing ISGs on the conveyor (optionally in the defined order), OFS uses one or more sensors to recognize (109) the items on the moving conveyor, and associates (110) each recognized items with the respective order ID to yield identified items.

In a following description, an item on the conveyor is referred to as “recognized” when OFS defines its matching product (and, accordingly, its product ID) with a confidence level matching a predefined criterion. A recognized item is referred to as an “identified item” when OFS associates its recognized product ID with respective order ID.

OFS provides recognition and identification operations separately for each ISG.

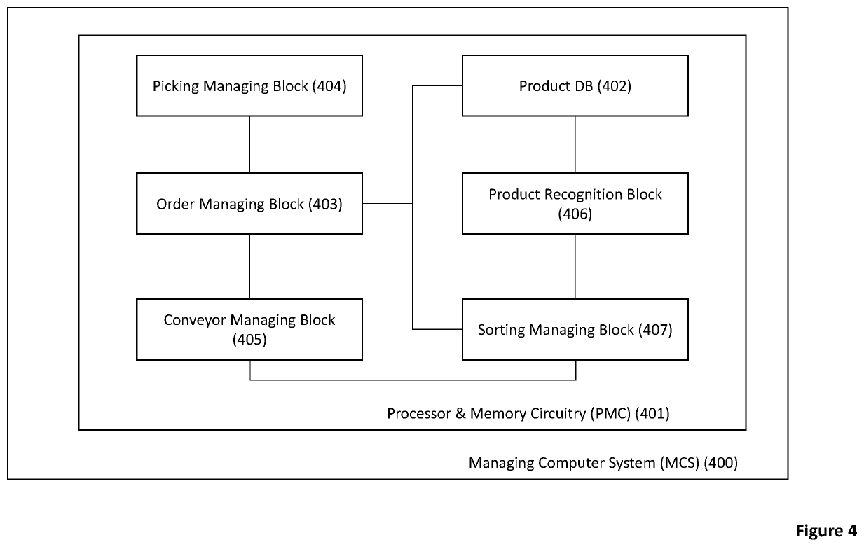

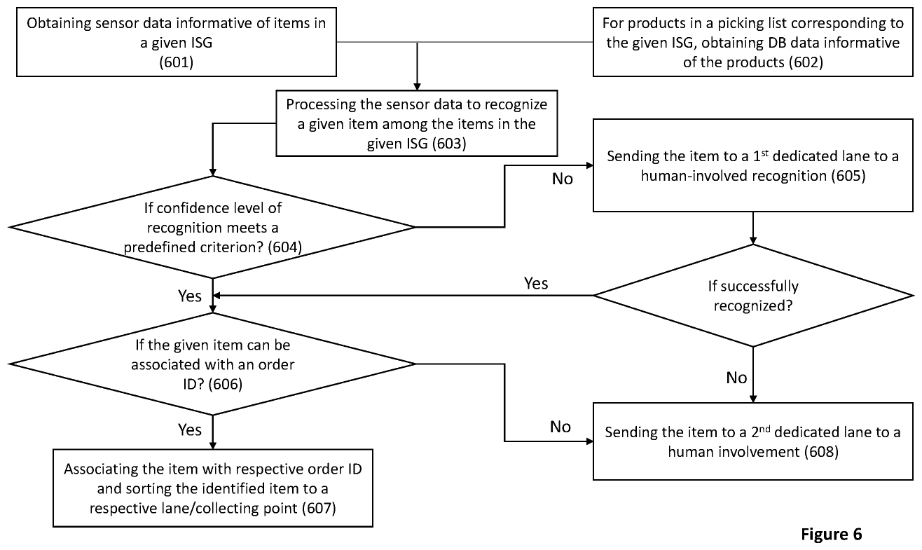

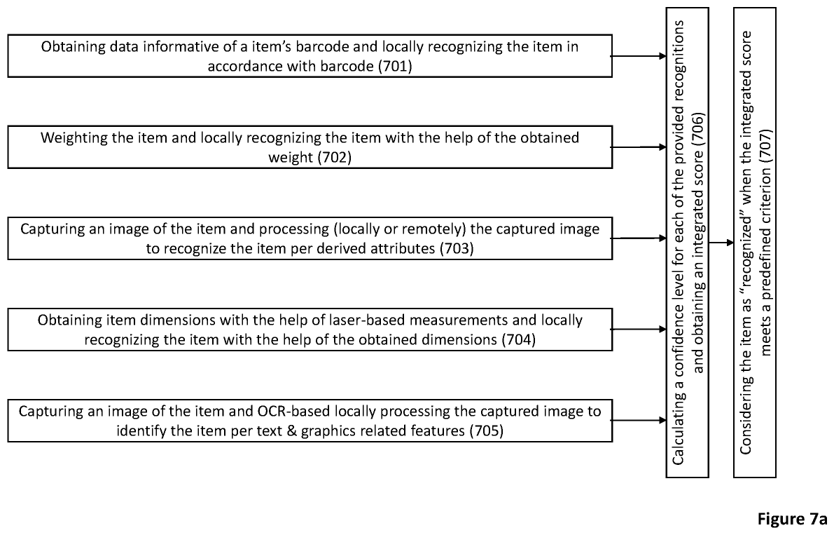

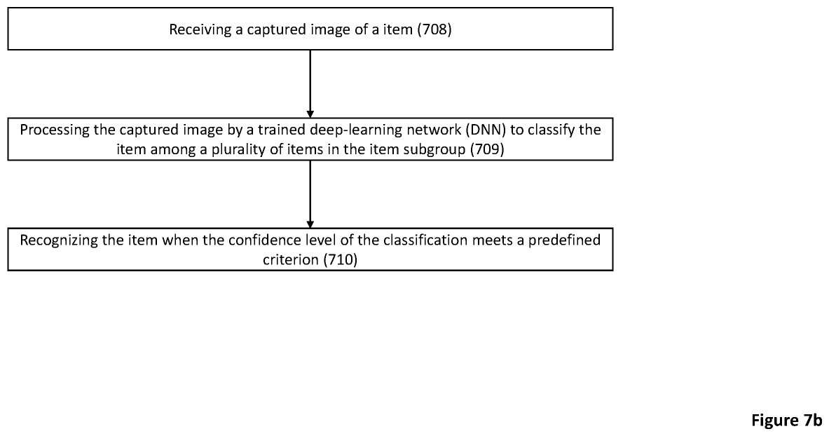

OFS further automatically sorts (111) each item identified in a respective item subgroup to a collecting point corresponding to its order ID. As will be further detailed with reference to FIG. 4, the non-identified items (if any) are sorted to a dedicated destination (lane and/or collecting point) for a manual identification. Recognizing the items and sorting thereof are further detailed with reference to FIGS. 6-7.

Optionally, generating a batch of orders, generating the plurality of picking lists therein and placing the item subgroups on the conveyor can be optimized in accordance with a combined criterion. Such combined criterion can enable an optimized overall process including the picking process and/or further sorting the items to the collecting points for optimized order packaging and fulfillment.

It is noted that the teachings of the presently disclosed subject matter are not bound by the above description. By way of non-limiting example, operations 108-111 can be applied to a group comprising a predefined number of sequentially placed ISGs. By way of another non-limiting example, operations 107-112 can be applied to a group comprising a predefined combination of ISGs. For example, configuring the conveyor system, defining the placing order, recognizing and sorting the items can be provided for a group of ISGs (e.g. a group comprising a plurality of ISGs with fruits and vegetables, a group comprising a plurality of ISGs of a certain category, etc.) in the manner similar to the described above with regard to a single ISG.

FIG. 2a illustrates a generalized flow-chart of the computerized order fulfilment with optimized placing the items on the conveyer.

As was detailed with reference to FIG. 1, OFS divides, in accordance with a picking criterion, the grouped product-list into a plurality of picking lists and enables picking (105) the physical products per picking lists to yield a plurality of item subgroups (ISGs).

In accordance with certain embodiments of the presently disclosed subject matter, a picker can place the items of a given ISG into one or more crates, each crate associated with a respective crate ID. OFS obtains (201) data indicative of product IDs of the items placed in each crate and associates crate ID(s) with the respective product IDs.

By way of non-limiting example, the picker can use a scanner to provide OFS with barcodes indicative of product IDs of the items placed in a given crate, thereby OFS can associate the product IDs of the items placed in the given crate with ID of the given crate. By way of another non-limiting example, such association can be provided automatically with the help of any suitable technique (e.g. based on automatic recognition of the placed items and of the given crate).

It is noted that the term “crate” used in this patent specification refers to any container suitable for collecting and transporting the products to the conveyor.

OFS further uses the product IDs associated with each given crate to define (202), for each crate, a “queue score” indicative of a priority of placing the items from the crate on the conveyor. For example, crates with heavy items (and/or large-dimensional items) can be provided with the highest queue score so to be packed first, while crates with crushable items can be provided with the lowest queue score so to be packed last.

Optionally, each product in the product data base can be associated with a queue score assigned thereto, and the queue score of a crate can be calculated as a function (e.g. average score weighted per number of product with a certain score) of queue scores of the respective items therein. Alternatively or additionally, each category of products (e.g. food/non-food, freeze/cool/room temperature, etc.) can be associated with a queue score. The queue score of a crate can be calculated as a queue score weighted per number of products of a certain category, as a queue score corresponding to a category with the highest queue score, etc.

Additionally or alternatively, the queue scores can be calculated in accordance with requirements related to further packaging the items in the orders. Such requirements can be configurable by MCS and not-necessarily comprised in the product DB.

After pickers place the crates on an automated feeder, OFS enables the feeder to upload (204) the items from the crates on the conveyor in accordance with the queue scores of respective crates, thereby enables placing the respective items in accordance with a desired order.

To enable the feeder to place the products in a desired order, OFS provides (203) the feeder with an indication of a “next for uploading” crate in a feeding queue, wherein the “next for uploading” crate is defined in accordance with queue scores of the crates in the feeding queue. Optionally, a feeding queue can comprise several crates indicated as “next to upload” and the feeder can select among such crates. Such selection can be provided in an arbitrary order or with further consideration of the time of placing a “next to upload” crate to the queue and/or other characteristics of the crates.

By way of non-limiting example, OFS can inform a picker about a calculated queue score of a given crate and the picker can provide the given crate with a physical “queue score” mark (e.g. a colored sticker) recognizable by the feeder. Thus, all crates in the feeding queue will be marked in accordance with their queue scores, and the feeder will select for uploading to the conveyor the crates with the highest scores among the crates in the queue.

By way of another non-limiting example, prior to selecting by the feeder a next crate for uploading, OFS can automatically inform the feeder (in pull or push mode) about the “next to upload” crate in the queue. For example, OFS can use IDs of the crates and data indicative of respectively placed items to define, among the crates in the queue, the crate(s) with the highest queue score. Accordingly, OFS can provide an indication (e.g. switch on a green light) associated with the “next to upload” crate(s) and recognizable by the feeder.

It is noted that items in a given crate can correspond to an entire ISG or to a part thereof. Thus, operations (201)-(204) can provide the placing order of ISGs and/or of items therein.

Optionally, placing the items on the conveyor can be further optimized by generating the picking lists with order of picking optimized in accordance, at least, with requirements related to further packaging the respective items (e.g. constrains of dimensions, weight, crushability, maximal time allowed without cooling, etc.). Such optimization of picking lists can maximize, for each crate, the number of items having the same queue score.

Optionally, the order of picking in the picking lists can be defined in accordance with an optimum between packaging-related requirements and at least one of: minimal picker walking distances, similarity of product attributes in, similarity of product categories, etc.

Additionally or alternatively to the optimization detailed with reference to FIG. 2a, the computerized order fulfilment can be optimized as illustrated by a generalized flow-chart in FIG. 2b.

Some of picking lists can comprise a plurality of products (referred to hereinafter as packageable products) requiring the same special handling (e.g. chilled and/or frozen items, fruits & vegetables, etc.), while such special handling can be provided by appropriate packaging. Such requirements are referred to hereinafter as “packageability requirements”. It is noted that packageability requirements can differ for different packageable products and the corresponding items (e.g. “keeping frozen” requirements for certain products, “keeping dry” requirements for other products, etc.) and can be specified in the respective attributes in the product DB.

In accordance with certain embodiments of the presently disclosed subject matter, OFS can be configured to recognize, within a picking list, packageable products with the same packageability requirements and belonging to the same order, to enable placing the respective items in an appropriate common physical “basket” (e.g. into a thermo-insulating and/or cooling package, etc.), and to enable sorting the basket on the conveyor in accordance with ID of the respective order.

It is noted that the packageability requirements are considered the same if they can be fulfilled with the help of the same packaging.

It is further noted that the term “physical basket” or “basket” used in this patent specification refers to any container suitable for collecting and transporting the packageable items to the conveyor in accordance with the respective packageability requirements.

As illustrated in FIG. 2b, OFS can generate (211) within a picking list one or more bundles, each specifying packageable products associated with the same order ID and having the same “packageability” requirements. OFS can be configured to generate a bundle when the number of the packageable products with a certain order ID exceeds a predefined threshold.

When a picker picks the items per the picking list, the items matching a given bundle are placed (212) in a common physical “basket” enabling the common “packageability” requirements of the bundled products. OFS provides (213) the basket with basket ID associated with respective order ID and with the product IDs of the items placed therein.

A number of packageable products in a bundle can be limited in accordance with a capacity of a respective basket, thus the picking list can comprise a plurality of bundles with the same packageability requirements and associated with the same order ID. Likewise, the picking list can comprise a plurality of bundles (associated with the same order ID) required to be wrapped separately (e.g. frozen dough and frozen meat) whilst having the same packageability requirements (e.g. keep frozen). Optionally, OFS can generate (214), within the picking list, an aggregated bundle including a plurality of bundles associated with the same order ID. The bundles within the aggregated bundle can have the same or compatible packageability requirements. By way of non-limiting example, for the same order ID within the picking list, one or more bundles with cooled products and one or more bundles with frozen products can be further aggregated in a common aggregated bundle enabling cooling together the bundles with frozen products and the bundles with cooled products.

Respectively, during picking, a corresponding plurality of baskets will be placed (215) into an aggregated basket corresponding to the aggregated bundle, and the aggregated basket will be provided with its own ID. ID of the aggregated basket is associated with respective order ID (common to all baskets therein) and with basket IDs of the baskets placed in the aggregated basket.

OFS further enables placing the baskets (including aggregated baskets if any) on the conveyor, recognizing the basket IDs and sorting (216) the baskets, “as a whole” with the items therein, to the destinations (lane/collecting point) mapped as corresponding to the order IDs associated with the recognized basket IDs.

OFS can enable a picker to print and put on a given basket a sticker recognizable during sorting on the conveyor and indicative of ID of the given basket. The OFS will recognize the basket ID and sort the baskets in accordance with order ID associated therewith. Optionally, the sticker can be further informative of the items placed within the basket and, in a case of an aggregated basket, also about the baskets therein. Alternatively or additionally, the data about items within the baskets can be kept in OFS and printed at the collecting points.

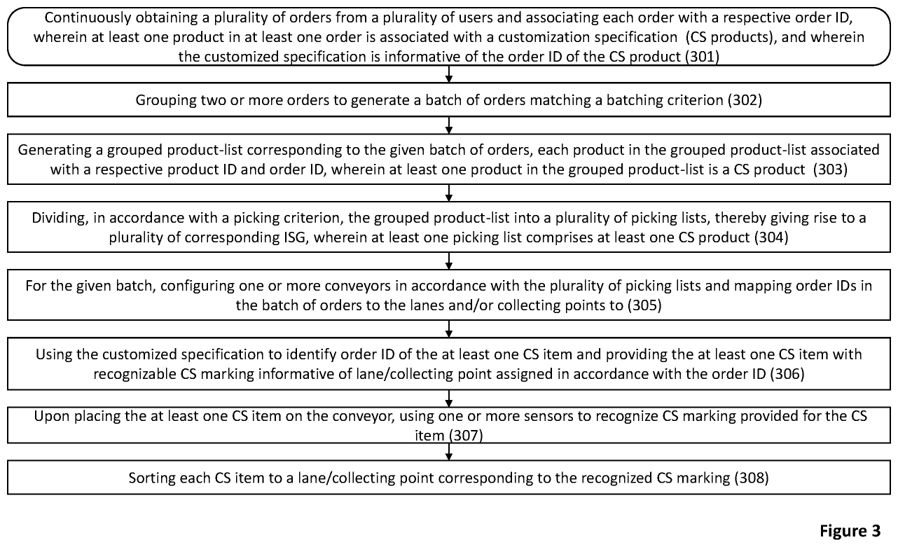

Referring to FIG. 3, there is illustrated a generalized flow-chart of order fulfilment with regard to customizable products.

In accordance with certain embodiments of the presently disclosed subject matter, the order fulfilment system (OFS) can be configured to handle customizable products (as a rule, such products being non-fungible products). OFS can be configured to enable the users to input customization data in an order, to generate customization specifications and to associate the products with respective customization specifications. Products associated with customization specification are referred thereto as CS products.

The term “customization specification” used in this patent specification should be expansively construed to cover any data informative of requirements for the product that are beyond the details indicatable by product ID (i.e. existing barcodes and/or product attributes specified in the product database).

By way of non-limiting example, for the “Weighable products”, regular barcode specifies the product type (e.g. apples, tomatoes, beef, salmon, Cheddar cheese, etc.) and its exact weight (e.g. 1.2 kg, 830 gr, etc.). Thus, for example, 1.2 kg of beef minced twice, 1.2 kg of beef cut to fingers, 1.2 kg of beef 1 piece and 1.2 kg of beef cut to cubes will have the same barcode. Even if OFS is configured to have separate barcodes for beef cut to fingers and beef cut to cubes, there can be a need in a customization specification beyond the details indicatable by barcodes (e.g. 1.2 kg of beef cut to cubes of certain size, bananas of certain maturity, etc.).

By way of another non-limiting example, a barcode of a non-fungible item can specify “a towel with embroidered name”, while the customization specification can detail the exact name to be embroidered.

Thus, the CS products, even if with the same product ID can be associated with different customization specifications and with different order IDs.

In the respective embodiments, OFS continuously obtains orders from a plurality of users and associates each order with a respective order ID, while at least one product in at least one order is associated with a customization specification (301), and wherein the customized specification is configured to be informative of the order ID of this CS product.

OFS groups two or more of the received orders and generates (302) a batch of orders matching a batching criterion characterizing what orders shall be grouped in a single batch in a manner described with the reference to FIG. 1.

For each given batch of orders, OFS generates (303) a grouped product-list corresponding to the given batch of orders, each product in the grouped product-list associated with a respective product ID and order ID.

In a manner described with the reference to FIGS. 1-2, OFS further divides the grouped product-list into a plurality of picking lists and enables the pickers to pick the respective items so to yield (304) a plurality of corresponding item subgroups, wherein at least one picking list comprise at least one CS product.

Optionally, but not necessarily so, the products associated with customization specifications (CS products) can be grouped in one or more separate picking lists and, accordingly, can yield one or more item subgroups (ISGs) comprising, merely, items picked in accordance with the customization specifications.

Items picked in accordance with customization specifications are referred to hereinafter as CS items.

CS items can be picked from one or more picking stations (referred to hereinafter as CS picking stations) capable of customizing the items in accordance with the customization specification (e.g. weighing stations for weighable items, customization points for personalized items (embroidering, printing, etc.). A CS picking station can be dedicated to CS items or can enable picking also non-CS items. It is noted that a customization specification (including an order ID) can be readable at CS picking stations in an electronic form, can be prior printed by a picker using data received from OFS, etc.

It is noted that the same product ID can be associated with different customization specifications. Accordingly, a combination of product ID and order ID does not uniquely characterize a CS product. Thus, recognizing product ID is not sufficient for identifying CS items, i.e. for defining its associated order ID for further sorting. Thus, in accordance with certain embodiments of the presently disclosed subject matter, CS items can be provided with special physical marking (referred to as CS marking) informative of respective lanes/collecting points desired for sorting thereto.

For a given CS item, OFS uses order ID specified in its customization specification to define its destination (lane/collecting point) mapped to this order ID and assigns this destination to the given CS product. OFS further enables providing (306) for the given CS item a physical CS marking informative of such assigned lane/collecting point. The CS marking is configured to be recognizable when the items are sorted on the conveyor.

By way of non-limiting example, such CS marking can be provided as an extension of a barcode (e.g. using one or more spare digits therein), using special labels or special materials, etc.

By way of non-limiting example, the CS marking can be physically provided to the given CS item at a respective CS picking station in accordance with data and/or instructions received from MCS.

After ISGs with CS items are placed on the conveyor, OFS uses one or more sensors to recognize (307) the provided CS marking and lanes/collecting points specified thereby, and sorts (308) each the CS item accordingly.

Optionally, ISGs that include, merely, CS items can be transported to special sensor(s) configured to recognize the CS marking informative of the desired lane/collecting point and/or can be further transported to special sorting arrangements configured to sort the CS products in accordance with the recognized CS marking.

Optionally, OFS can be further configured to have special placing locations (e.g. special area on a conveyor, special auxiliary sub-conveyor, etc.) for ISGs that include, merely, CS items.

It is noted that providing the recognizable CS marking indicative of a desired lane/collecting point enables automated sorting CS items from different orders and with different customization specifications, but having the same product ID.

Referring to FIG. 4, there is illustrated a functional block diagram of the managing computer system (MCS) in accordance with certain embodiments of the presently disclosed subject matter. MCS 400 comprises a processor and memory circuitry (PMC) 401. PMC 401 is configured to provide all processing necessary for MCS operation as detailed with reference to FIGS. 1-3 and FIGS. 5-6. PMC 401 comprises a processor (not shown separately) and a memory (not shown separately). The processor of PMC 401 can be configured to execute several functional modules in accordance with computer-readable instructions implemented on a non-transitory computer-readable memory comprised in the PMC. Such executable functional modules are referred to hereinafter as comprised in the PMC. The functional blocks can be implemented in any appropriate combination of software with firmware and/or hardware.

Functional modules comprised in the PMC 401 can include operatively connected product database 402, order managing block 403, picking managing block 404, conveyor managing block 405, product recognition block 406, and sorting managing block 407.

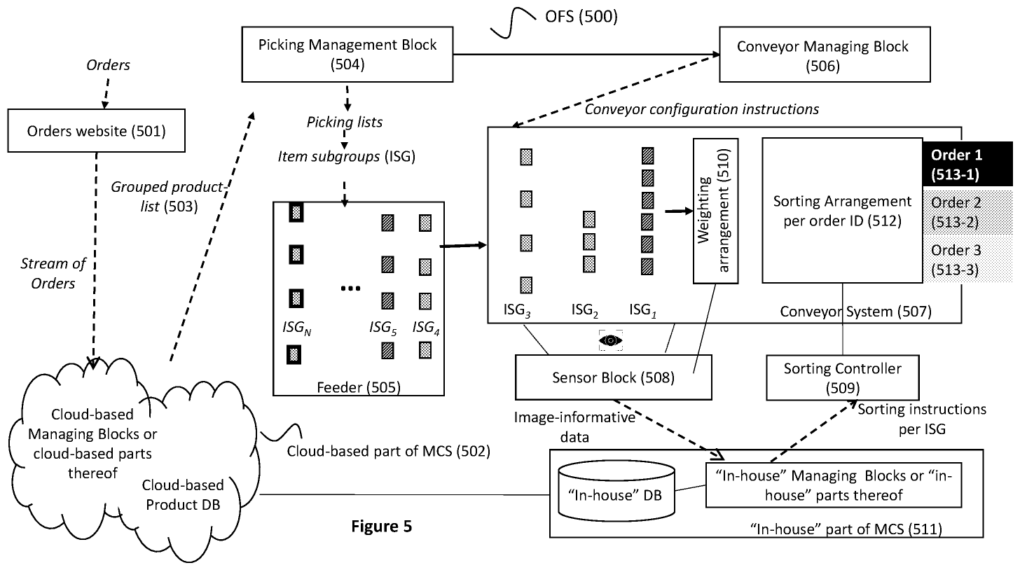

Functions of the blocks are further detailed with reference to FIGS. 5-7.

Those versed in the art will readily appreciate that the teachings of the presently disclosed subject matter are not bound by the system illustrated in FIG. 4; equivalent and/or modified functionality can be consolidated or divided in another manner and can be implemented in any appropriate combination of software with firmware and hardware.

It is noted that the MCS illustrated in FIG. 4 can be implemented in a distributed and/or cloud and/or virtualized computing environment. The functional modules (and/or parts thereof) shown in FIG. 4 can be distributed over several local and/or remote computers (including computers located in a cloud environment), and can be linked through a communication network.

Referring to FIG. 5, there is illustrated a generalized schematic architecture of an exemplified order fulfilment system (OFS) in accordance with certain embodiments of the presently disclosed subject matter. For purpose of illustration only, the following description is provided for operations provided with ISG-based granularity. Those skilled in the art will readily appreciate that the teachings of the presently disclosed subject matter are, likewise, applicable to a granularity of a group of ISGs matching a predefined criterion. Non-limiting examples of such ISG groups are detailed with reference to FIG. 1.

The illustrated OFS 500 comprises managing computer system (MCS) divided into a cloud-based part 502 and “in-house” part 511. The exemplified functional blocks of MCS are illustrated in FIG. 4, the blocks and/or parts thereof can be distributed between the cloud-based part and the “in-house” part using any appropriate technique, some of them known in the art. In the illustrated example, cloud-based part 502 comprises an order managing block, a cloud-based part of product database (DB) and a cloud-based part of product recognition block. The “in-house” part 511 comprises a picking management block 504 (presented separately for simplicity of illustration), an “in-house” part of product DB, “in-house” part of conveyor managing block, product recognition block and sorting managing block.

By way of non-limiting example, the functionality of “cloud-based” part of MCS and/or blocks therein can be (but not necessary so) provided by computer(s) hosted by a 3^{rd} party (e.g. as Software as a Service (SaaS)), while the functionality of “in-house” part of MCS and/or blocks can be provided by local or remote computer(s) hosted by a provider of the order fulfilment service.

OFC 500 further comprises an orders website 501 operatively connected to cloud-based part 502 of MCS. Order website 501 is configured to continuously receive the orders from the users and transfer data informative of the received orders to cloud-based part 502 of MCS. Optionally, orders website 501 can be further configured to generate the batches of orders in a manner detailed with reference to FIG. 1.

Cloud-based part 502 of MCS (e.g. order management block) is configured to generate the batches of orders in accordance with order-related data received from order web site 501 and to generate, for each batch of orders, a grouped product-list 503 comprising all products ordered in the batch of orders.

The generated grouped product-list 503 is received by picking management block 504. Picking management block 504 is configured to process the grouped product list to generate picking lists and enable creating the respective item subgroups (ISG). Each product in a picking list is associated with a product ID and order ID. Picking management block 504 can be further configured to define the order of placing the item subgroups on the conveyor. Respective picking lists and instructions of order of picking and/or placing are provided to a plurality of human and/or automated pickers in any appropriate manner known in the art.

Picking management block 504 is operatively connected to conveyor managing block 506 configured to define, for each batch and in accordance with the generated plurality of picking lists, configuration of conveyor system 507. Configuration instructions can be received and implemented by a configuration controller (not presented in FIG. 5) operatively connected to conveyor managing block 506 and to conveyor system 507.

Picking management block 504 and conveyor managing block 506 can be comprised in cloud-based part 502 of MCS or “in-house” part 311 of MCS. It is noted that, optionally, picking management block 504 and/or conveyor managing block 506 can operate in SaaS manner.

In the illustrated embodiments, order website 501 and cloud-based part 302 of MCS can serve, in Software as a Service (SaaS) manner, a plurality of packing arrangements of on-line or hybrid stores, the packing points being served by a plurality of providers of order fulfilment and related services. Picking management block 504 and conveyor managing block 306 are illustrated as “in-house”, hosted by a given service provider and dedicated to certain one or more packing arrangements served by the given service provider.

Upon physical picking, item subgroups (ISGs) are placed on one or more conveyors. Optionally, ISGs can be placed on the one or more conveyors with the help of a feeder 505 configured to place the ISGs on the conveyor in accordance with the defined order of placing. Each ISG is placed in a separated manner to enable recognition of belonging the items to respective ISG for the purposes of further processing.

In the illustrated example, for simplification purposes, conveyor system 507 comprises only a single conveyor, and all ISGs are to be placed on this conveyor in accordance with the defined sequence (ISG₁->ISG_{N}).

Optionally, the conveyor can be configured to ensure a separate placing for each ISG.

Conveyor system 507 comprises a sorting arrangement 512 configured to sort the items in each ISG in accordance with instructions received from a sorting controller 509. Sorting arrangement 512 sorts the items into a plurality of lanes (depicted as 513-1-513-3), each given lane associated with a given order ID and enables delivery of the respective items to one or more collecting points associated with the given order ID.

OFS further comprises a sensor block 508 configured to obtain data informative of the items in a ISG moving on the conveyor, such data enabling recognition of these items (referred to hereinafter as “sensor data”). The sensor block comprises one or more sensors of the same or of different modalities. By way of non-limiting example, the sensors in sensor block 508 can be usable for at least one of: barcode scanning, capturing image for OCR-based processing, high-resolution capturing one or more images of the item, capturing 3D or stereo images of the item to define dimensions, form and/or texture, laser-based sensing to define dimensions, etc. Optionally, sensor block 508 can comprise also weighting arrangement 510 configured to define weights of the items in a given ISG. Thus, sensor data of a given item can comprise data obtained from one or more modalities. It is noted that image data within the sensor data can comprise a plurality of images of the same item received from the same or from different modalities.

Sensor block 508 is operatively connected to “in-house” part 511 of MCS and transfers thereto the sensor data informative of items in a given ISG.

Sensors in sensor block 508 can be configured to receive, at a time, sensor information about items in a single ISG. Alternatively, at least some sensors in the sensor block can be configured to simultaneously obtain information about the items in a predefined number (>1) of ISGs. By way of non-limiting example, one or more imaging sensors can have a field of view covering a predefined number (>1) of ISGs. In such embodiments, sensor block 508 can be configured to associate sensor data of items with data informative of ISG they belong to. By way of non-limiting example, conveyor 507 can have dedicated separate placement for each next ISG, each dedicated placement marked in a manner enabling identification of the placement by sensor block 508 and, thereby enabling association of the item sensor data with respective ISGs. Optionally, at a given point of time, different sensors in sensor block 508 can obtain information from different ISGs. For example, sensor block 508 can obtain weights of the items in ISGᵢ simultaneously with capturing images of items in ISGᵢ₊₁.

It is noted that in accordance with certain embodiments of the presently disclosed subject matter, sensor data obtained for a given item are informative of a corresponding ISG. Association of sensor data with respective ISG can be provided by sensor block 508, prior to transferring data to MCS and/or by MSC, using information comprised in the sensor data (e.g. respective timestamps, conveyor-related indications, etc.).

Optionally, sensor block 508 can include processing resources capable of pre-processing the sensor data prior to sending it to MCS.

For a given ISG, “in-house” part 511 of MCS (e.g. product recognition block) processes sensor data to recognize each given item (i.e. define a matching product and respective product ID among the plurality of products corresponding to the ISG), associates the recognized item with corresponding order ID and generates and provides (e.g. sorting managing block and/or conveyor managing block) sorting instructions to sorting controller 509. It is noted that, optionally, item recognition and/or identification can be wholly or partly provided by cloud-based part 502 of MCS.

Those versed in the art will readily appreciate that the teachings of the presently disclosed subject matter are not bound by the system illustrated in FIG. 5; equivalent and/or modified functionality can be consolidated or divided in another manner and can be implemented in any appropriate combination of software with firmware and hardware. Likewise, equivalent and/or modified functionality can be divided in another manner between the cloud-based and “in-house” parts of MCS.

It is further noted that the features of embodiments detailed with reference to FIGS. 1-3 can be combined therebetween in any suitable combination, while MCS and OFS detailed with reference to FIGS. 4-5 can be configured to support any of such suitable combination.

Referring to FIG. 6, there is illustrated a generalized flow-chart of item sorting. In accordance with certain embodiments of the presently disclosed subject matter, MCS obtains (601) sensor data informative of items in a given ISG and obtains (602) data informative of products and respective order IDs specified in a picking list corresponding to the given ISG. Data informative of products include IDs of the products specified in the picking list corresponding to the given ISG and at least part of their attributes as stored in product DB. MCS processes the sensor data and data informative of products to recognize (603) a given item (i.e. define a matching product and respective product ID among the products in the picking list corresponding to the given ISG). MSC checks (604) if a confidence level of matching meets a recognition criterion and if Yes, the item is considered as successfully recognized by MSC. If the confidence level of recognition doesn't meet the recognition criterion, MCS sends (605) the item to a 1^{st} lane dedicated to a human involvement in controlled visual recognition (“controlled manual recognition”).

MSC uses the product ID (referred to hereinafter as ID_{P}) associated with a successfully recognized (automatically or manually) item, to associate the item with an order ID among the order IDs specified in the corresponding picking list for product ID_{P}. By way of non-limiting example, MSC can define, for the corresponding picking list, a set of all, one or more, pairs constituted by ID_{P} and order ID(s), select an available pair (i.e. a pair that has not yet been used for associating an order ID) and associate the order ID in the selected pair with the recognized item. Selecting the available pair can be provided in an arbitrary manner or in accordance with a predefined criterion.

Thus, MSC checks (606) if a given item with a recognized product ID can be associated with an order ID among the order IDs specified in the corresponding picking list for the respective product ID. If Yes, MCS identifies the item by associating the product ID with the respective order ID and sorts (607) the identified item to a destination (lane and/or collecting point) corresponding to this order ID. If the recognized item cannot be associated with an order ID among the order IDs corresponding to the given ISG (e.g. the item has been picked and/or placed by mistake), MSC enables sorting the item to a 2^{nd} lane dedicated to human involvement into decisions how to handle the items from this lane (e.g. return back to the store). Optionally, the unsuccessfully recognized items can be, also, sorted to the 2^{nd} dedicated lane. It is noted that in certain embodiments MCS can receive sensor data informative of items in several ISGs and, prior to the further processing, select sensor data informative of items in the given ISG. It is further noted that the teachings of the presently disclosed subject matter are, likewise, applicable to recognizing a given item among items of a predefined number and/or predefined combination of ISGs.

Among advantages of certain embodiments of the presently disclosed subject matter is enabling item identification among the reduced number of candidates (i.e. among products belonging to a respective picking list or a group of picking lists) and, thereby reducing processing power and time required for item sorting and improving the accuracy of identification.

Processing sensor data to recognize the items in accordance with their known attributes can be provided by any appropriate technique, some of them known in the art. Optionally, item recognition can be provided by novel techniques proposed by the inventors and detailed below.

In accordance with certain embodiments of the presently disclosed subject matter, the item recognition can include: obtaining sensor data from a first modality and recognizing the item in accordance with product attributes relevant to the first modality; if confidence level of the first recognition does not meet a predefined criterion, obtaining sensor data from a second modality and further recognizing the item in accordance with product attributes relevant to the second modality; continuing the process upon reaching a completion criterion (e.g. meeting a threshold for confidence level, elapsing of processing time, completion of available modalities, etc.). By way of non-limiting example, the recognition operations can be provided in the following order: barcode recognition vs. plurality of barcodes corresponding to a given ISG; weight recognition vs. plurality of weights corresponding to the given ISG; 2D or 3D dimension recognition vs. plurality of 2D/3D dimensions corresponding to the given ISG; image recognition vs. plurality of image templates corresponding to the given ISG; image recognition vs. sets of product attributes corresponding to the given ISG; OCR-based recognition vs. plurality of texts, graphics and colors corresponding to the given ISG, etc.

In accordance with other embodiments of the presently disclosed subject matter, the item recognition can include: obtaining sensor data from different modalities; for each given modality, recognizing the item in accordance with product attributes relevant to the given modality; calculating a confidence level for each of identifications and obtaining an integrated score; and considering the item as “recognized” when the integrated score meets a recognition criterion (e.g. the integrated score is lower than a predefined threshold).

FIG. 7a illustrates a non-limiting example of a generalized flow-chart of item recognition in accordance with certain embodiments of the presently disclosed subject matter. MCS provides at least two of the following recognition process: obtaining data informative of a item's barcode and locally recognizing the item in accordance with barcodes specified for the products corresponding to a given ISG (701); weighting the item and locally recognizing the item with the help of the obtained weight vs. specified in the product DB weights of products corresponding to the given ISG (702); capturing an image of the item and processing (locally and/or cloud-based) the captured image to recognize the item comparing the derived attributes vs. attributes specified in the product DB for the products corresponding to the given ISG (703); obtaining item dimensions with the help of laser-based measurements and locally recognizing the item with the help of the obtained dimensions (704); capturing an image of the item and OCR-based locally processing the captured image to recognize the item per text & graphics related features specified in the product DB for the products corresponding to the given ISG (705). MCS further calculates a confidence level for each of the provided recognitions and obtains (706) an integrated score (e.g. weighted average). The item is considered as “recognized” when the integrated score meets (707) a predefined criterion.

FIG. 7b illustrates another non-limiting example of a generalized flow-chart of item recognition in accordance with certain embodiments of the presently disclosed subject matter.

Upon receiving (708) a captured image of an item, MCS processes the captured image by a trained deep-learning network (DNN) to classify (709) the item among a plurality of products in the respective picking list, and recognizes (710) the item when the confidence level of the classification meets a predefined criterion. By way of non-limiting example, training of DNN can be provided for classifying, for each given sub-store, the items in sub-store (and/or predefined combination thereof). In such embodiments, picking criterion can be related to the sub-stores and all items in a given ISG can correspond to a single sub-store or a predefined combination of sub-stores.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, implemented on a suitably programmed computer. Likewise, the invention contemplates a computer program being readable by a computer for executing the method of the invention. The invention further contemplates a non-transitory computer-readable memory tangibly embodying a program of instructions executable by the computer for executing the method of the invention.

Those skilled in the art will readily appreciate that various modifications and changes can be applied to the embodiments of the invention as hereinbefore described without departing from its scope, defined in and by the appended claims.

1. A computerized method of orders' fulfilling, the method comprising:
by a computer
obtaining a grouped product-list corresponding to a plurality of orders received from a plurality of users and grouped into a batch of orders, each product in the grouped product-list being associated with a respective product ID and order ID;
dividing the grouped product-list into a plurality of picking lists, each product in the picking lists being respectively associated with product ID and order ID, wherein the dividing is provided in accordance with a picking criterion related to the products' attributes and/or a picking process;
enabling picking items per the plurality of picking lists to yield a plurality of corresponding item subgroups (ISGs), wherein, in each ISG, picked items therein match to products in a respective picking list;
obtaining data informative of mapping between order IDs in the at least one batch of orders and destinations on a conveyor;
separately for each given ISG:
placing the items therefrom on the conveyor;
recognizing the items using data from one or more sensors sensing the items on the conveyor, thereby associating the items in the given ISG with product IDs of respective matching products, wherein for each given item the recognizing is provided merely among the products specified in a corresponding picking list;
for each given recognized item, using the associated product ID to further associate the given item with respective order ID, thereby yielding identified items; and
using the associated order IDs to sort the identified items to destinations defined in accordance with the data informative of mapping between the destinations and order IDs.

2. The method of claim 1, further comprising for each ISG:
upon placing items from a given ISG on the conveyor, obtaining sensor data informative of the items in a given ISG and obtaining data informative of products and respective order IDs specified in a corresponding picking list;
processing the sensor data and data informative of products to identify, for each item, a matching product among the products in the corresponding picking list, wherein processing the data informative of products is provided, merely, with regard to the products specified in the corresponding picking list;
for each item, when a confidence level of matching meets a recognition criterion, associating the item with product IDs of the respective matching products to yield recognized items; and
for each recognized item, using respective associated product ID to associate the item with an order ID among the order IDs specified in the corresponding picking list, the order ID further usable for sorting the item to a respective destination.

3. The method of claim 1, further comprising:
enabling picking the items in at least one ISG into one or more crates, each crate associated with a respective crate ID;
obtaining data indicative of product IDs of the items placed in each of the one or more crates and associating each crate ID with the respective product IDs;
for each of the one or more crates, using the product IDs associated with its crate ID to define a “queue score” indicative of a priority of placing the items from the crate on the conveyor; and
enabling uploading the items from the crates on the conveyor in accordance with the queue scores of respective crates.

4. The method of claim 3, wherein the queue scores of the one or more crates are calculated in accordance with requirements related to further packaging the items in the orders.

5. The method of claim 3, wherein each product in a picking list corresponding to the at least one ISG is associated with a queue score assigned thereto, and the queue score of each crate is calculated as a function of queue scores of the respective items therein.

6. The method of claim 3, wherein each product in a picking list corresponding to the at least one ISG is associated with a category of products with a preassigned queue score, and the queue score of each crate is calculated as a function of queue scores of the categories associated with respective items therein.

7. The method of claim 1, wherein at least one picking list is configured to enable picking the items in an order defined in accordance with requirements related to further packaging the respective items.

8. The method of claim 1, the method further comprising:
recognizing, within at least one picking list, one or more products with the same packageability requirements and associated with a common order ID;
enabling placing the items corresponding to the recognized one or more products in a common physical basket matching the packageability requirements; and
enabling sorting the physical basket on the conveyor to a destination corresponding to the common order ID.

9. The method of claim 8, further comprising:
generating within the at least one picking list at least one bundle specifying the one or more products with the same packageability requirements and associated with the common order ID;
enabling placing the items matching the at least one bundle in the common physical basket and providing the physical basket with basket ID associated with the common order ID and with the product IDs of the items placed therein; and
upon placing the physical baskets on the conveyor, recognizing the basket ID and sorting the physical basket on the conveyor to the destination corresponding to the order ID associated with the recognized basket ID.

10. The method of claim 8, further comprising:
generating within the at least one picking list a plurality of bundles associated with the common order ID and aggregating the bundles into an aggregated bundle;
for each bundle, enabling placing the items matching a given bundle in a respective common physical basket to yield a plurality of physical baskets corresponding to the plurality of bundles;
enabling placing the plurality of physical baskets into an aggregated physical basket and assigning to the aggregated physical basket a basket ID associated with the common order ID and with the basket IDs of the physical baskets placed therein; and
upon placing the aggregated physical basket on the conveyor, recognizing the basket ID and sorting the aggregated physical basket on the conveyor to the destination corresponding to the common order ID.

11. The method of claim 1, wherein at least one product (CS product) in at least one picking list is associated with a customization specification informative of the order ID and of user-specified requirements for the at least one CS product, the requirements being beyond details indicatable by product ID, the method further comprising:
upon picking a CS item corresponding to the at least one CS product, using the customized specification to identify order ID corresponding to the CS item and providing the CS item with a recognizable CS marking informative of a destination assigned in accordance with the order ID; and
upon placing the CS item on the conveyor, recognizing the CS marking and sorting the CS item to the destination corresponding to the recognized CS marking.

12. One or more computing devices comprising processors and memory, the one or more computing devices configured, via computer-executable instructions, to perform operations for operating, in a cloud computing environment, a system capable of managing order fulfilment, the operations comprising:
obtaining a grouped product-list corresponding to a plurality of orders received from a plurality of users and grouped into a batch of orders, each product in the grouped product-list being associated with a respective product ID and order ID;
dividing the grouped product-list into a plurality of picking lists, each product in the picking lists being respectively associated with product ID and order ID, wherein the dividing is provided in accordance with a picking criterion related to the products' attributes and/or a picking process;
enabling picking items per the plurality of picking lists to yield a plurality of corresponding item subgroups (ISGs), wherein, in each ISG, picked items therein match to products in a respective picking list;
obtaining data informative of mapping between order IDs in the at least one batch of orders and destinations on a conveyor;
separately for each given ISG:
placing the items therefrom on the conveyor;
recognizing the items using data from one or more sensors sensing the items on the conveyor to associate the items in the given ISG with product IDs of respective matching products, wherein for each given item the recognizing is provided merely among the products specified in a corresponding picking list;
for each given recognized item, using the associated product ID to further associate the given item with respective order ID, thereby yielding identified items; and
using the associated order IDs to sort the identified items to destinations defined in accordance with the data informative of mapping between the destinations and order IDs.

13. The one or more computing devices of claim 12, wherein the operations further comprise for each ISG:
upon placing items from a given ISG on the conveyor, obtaining sensor data informative of the items in a given ISG and obtaining data informative of products and respective order IDs specified in a corresponding picking list;
processing the sensor data and data informative of products to identify, for each item, a matching product among the products in the corresponding picking list, wherein processing the data informative of products is provided, merely, with regard to the products specified in the corresponding picking list;
for each item, when a confidence level of matching meets a recognition criterion, associating the item with product IDs of the respective matching products to yield recognized items; and
for each recognized item, using respective associated product ID to associate the item with an order ID among the order IDs specified in the corresponding picking list, the order ID further usable for sorting the item to a respective destination.

14. The one or more computing devices of claim 12, wherein the operations further comprise:
enabling picking the items in at least one ISG into one or more crates, each crate associated with a respective crate ID;
obtaining data indicative of product IDs of the items placed in each of the one or more crates and associating each crate ID with the respective product IDs;
for each of the one or more crates, using the product IDs associated with its crate ID to define a “queue score” indicative of a priority of placing the items from the crate on the conveyor; and
enabling uploading the items from the crates on the conveyor in accordance with the queue scores of respective crates.

15. The one or more computing devices of claim 14, wherein each product in a picking list corresponding to the at least one ISG is associated with a queue score assigned thereto, and the queue score of each crate is calculated as a function of queue scores of the respective items therein.

16. The one or more computing devices of claim 14, wherein each product in a picking list corresponding to the at least one ISG is associated with a category of products with a preassigned queue score, and the queue score of each crate is calculated as a function of queue scores of the categories associated with respective items therein.

17. The one or more computing devices of claim 12, wherein the operations further comprise:
recognizing, within at least one picking list, one or more products with the same packageability requirements and associated with a common order ID;
enabling placing the items corresponding to the recognized one or more products in a common physical basket matching the packageability requirements; and
enabling sorting the physical basket on the conveyor to a destination corresponding to the common order ID.

18. The one or more computing devices of claim 17, wherein the operations further comprise:
generating within the at least one picking list at least one bundle specifying the one or more products with the same packageability requirements and associated with the common order ID;
enabling placing the items matching the at least one bundle in the common physical basket and providing the physical basket with basket ID associated with the common order ID and with the product IDs of the items placed therein; and
upon placing the physical baskets on the conveyor, recognizing the basket ID and sorting the physical basket on the conveyor to the destination corresponding to the order ID associated with the recognized basket ID.

19. The one or more computing devices of claim 17, wherein the operations further comprise:
generating within the at least one picking list a plurality of bundles associated with the common order ID and aggregating the bundles into an aggregated bundle;
for each bundle, enabling placing the items matching a given bundle in a respective common physical basket to yield a plurality of physical baskets corresponding to the plurality of bundles;
enabling placing the plurality of physical baskets into an aggregated physical basket and assigning to the aggregated physical basket a basket ID associated with the common order ID and with the basket IDs of the physical baskets placed therein; and
upon placing the aggregated physical basket on the conveyor, recognizing the basket ID and sorting the aggregated physical basket on the conveyor to the destination corresponding to the common order ID.

20. The one or more computing devices of claim 12, wherein at least one product (CS product) in at least one picking list is associated with a customization specification informative of the order ID and of user-specified requirements for the at least one CS product, the requirements being beyond details indicatable by product ID, wherein the operations further comprise:
upon picking a CS item corresponding to the at least one CS product, using the customized specification to identify order ID corresponding to the CS item and providing the CS item with a recognizable CS marking informative of a destination assigned in accordance with the order ID; and
upon placing the CS item on the conveyor, recognizing the CS marking and sorting the CS item to the destination corresponding to the recognized CS marking.

21. A non-transitory computer-readable medium comprising instructions that, when executed by a computing system comprising a memory storing a plurality of program components executable by the computing system, cause the computing system to:
obtain a grouped product-list corresponding to a plurality of orders received from a plurality of users and grouped into a batch of orders, each product in the grouped product-list being associated with a respective product ID and order ID;
divide the grouped product-list into a plurality of picking lists, each product in the picking lists being respectively associated with product ID and order ID, wherein the dividing is provided in accordance with a picking criterion related to the products' attributes and/or a picking process;
enable picking items per the plurality of picking lists to yield a plurality of corresponding item subgroups (ISGs), wherein, in each ISG, picked items therein match to products in a respective picking list;
obtain data informative of mapping between order IDs in the at least one batch of orders and destinations on a conveyor;
separately for each given ISG:
place the items therefrom on the conveyor;
recognize the items using data from one or more sensors sensing the items on the conveyor, thereby associating the items in the given ISG with product IDs of respective matching products, wherein for each given item the recognizing is provided merely among the products specified in a corresponding picking list;
for each given recognized item, use the associated product ID to further associate the given item with respective order ID, thereby yielding identified items; and
use the associated order IDs to sort the identified items to destinations defined in accordance with the data informative of mapping between the destinations and order IDs.
